(19) United States
(12) Patent Application Publication
(10) Pub. No.: US 2016/0110730 A1
(43) Pub. Date: Apr. 21, 2016

(54) SYSTEM, METHOD AND COMPUTER-ACCESSIBLE MEDIUM FOR PREDICTING USER DEMOGRAPHICS OF ONLINE ITEMS

(71) Applicant: NEW YORK UNIVERSITY, New York, NY (US)

(72) Inventors: Foster Provost, New York, NY (US); David Martens, Berchem (BE)

(21) Appl. No.: 14/888,513

(22) PCT Filed: May 2, 2014
(86) PCT No.: PCT/US14/36630

§ 371 Date: Nov. 2, 2015

Related U.S. Application Data
(60) Provisional application No. 61/818,762, filed on May 2, 2013.

(51) Int. Cl. G06Q 30/02; G06Q 10/06

(52) U.S. Cl. CPC G06Q 30/0201; G06Q 10/067

(57) ABSTRACT

Exemplary systems, methods and computer-accessible mediums for generating a demographics model can be provided, which can include, for example, receiving information related to content information, generating a plurality of clusters based on the content information, and generating a demographics model based on demographics information for each of the clusters.

### CROSS-REFERENCE TO RELATED APPLICATIONS

This application relates to and claims priority from U.S. Patent Application No. 61/818,762, filed on May 2, 2013, the entire disclosure of which is incorporated herein by reference.

### FIELD OF THE DISCLOSURE

The present disclosure relates generally to a prediction of user demographics, and more specifically, to exemplary embodiments of systems, methods and computer-accessible mediums for predicting user demographics of, for example, online news items.

### BACKGROUND INFORMATION

Targeting based on demographics data (e.g., age, gender or occupation) can be an important and common method of targeting ads. Similar to how online firms facilitate targeting based on demographics, advertisers can want to place ads on webpages that can be visited by users of certain demographics.

To obtain the demographics data per web page on at least a subset of the visitors, three previous approaches have been used. (See, e.g., Reference 9). (See also, e.g., U.S. Pat. No. 7,882,745, the entire disclosure of which is hereby incorporated by reference in its entirety). In a panel approach, for example, a number of users can be invited to provide their demographics, and their browsing behavior can be monitored by installing a piece of software on their computer. In a survey approach, for example, visitors of a webpage can be asked to provide their demographic data. Responses to these approaches can typically be rather low, and these approaches may not be scalable, certainly not for a large number of web pages. The third approach can be to predict the demographics for each web page.

A common approach can be use webpage visitation data to predict demographics (see, e.g., Reference 1) to create what can be called cluster centroids per value for the demographic. So, for example, if gender is to be predicted, two clusters can be created, one for male users and one for females. The cluster centroid can be the average of all instances in a matrix (e.g., Matrix A) which can denote, for each user/row, which webpages/columns have been visited by that gender. When a new page is to be classified, the distance between that new page visited by users and the cluster centroids can be measured, and the gender of the closest centroid can be the predicted one. When clustering procedures are not used, a history of user-webpage visits can be used (see, e.g., Reference 11), or a Latent Semantic Analysis can be applied to the Matrix A to create a reduced vector space of web usage data. (See, e.g., Reference 11).

A classification procedure, such as an artificial neural network, can be used to predict the demographic, which can use (a) the reduced matrix as input data (see, Reference 3). Random forests can be applied directly on the featurized webpage visitation data (see, e.g., Reference 3), or pair-wise relations (e.g., direct clicks) between webpages can be used to predict demographic information. (See e.g., Reference 8). By using the probability that a webpage can be connected to other webpages for which the demographic can be known, a predicted value can be obtained by a simple weighted average. A similar approach can be taken by iteratively scoring webpages by the average known/estimated demographic of the visitors, and the visitors of those webpages. (See, e.g., Reference 9). However, these known methods rely on having demographic data on the users who have visited the webpage, which is generally not available.

User demographics can also be predicted using the words that can be present on the webpage (see, e.g., Reference 7), which can use support vector regression (see, e.g., Reference 6), content, demographic and user-news item data. First, the demographic per webpage can be inferred by aggregating information for the users that viewed that webpage. Next, the demographics of web pages can be predicted, with target variables of previous estimates, based on the content of that webpage, such that all web pages that have not been visited can be scored. These predictions can then be smoothed by looking at similar webpages based on the user-webpage visit data. However, the latter may only likely be applicable for webpages that have been read by sufficient users, and may not be applicable for new webpages. For new webpages, only the content-based prediction can be available. The last component, where the demographics of similar users that visit similar webpages can be taken into account, may not be used for webpages that have not received sufficient visits to have information about the webpage inferred.

Other data that can be used, but can be of less relevance, can include the hyper-link structure of the webpages (e.g., the links to other pages) (see, e.g., Reference 7), or also using search terms. The demographics of members of a social network can be predicted based on the age of online friends, or the age of all the members of the website. (See, e.g., References 2 and 13). User demographics can be predicted based on the searches they make, by linking Facebook likes with the queries, and using the known demographics of the Facebook likes to make predictions for that query.

Thus, it may be beneficial to provide exemplary systems, methods and computer-accessible mediums that can predict user demographics of, for example, online news items without the need for sufficient prior knowledge of the webpage or the user, and which can overcome at least some of the deficiencies described herein above.

### SUMMARY OF EXEMPLARY EMBODIMENTS

According to an exemplary embodiment of the present disclosure, to address at least some of such deficiencies, systems, methods and computer-accessible mediums can be provided using an online news publishers, which can have a continuous flow of new web pages (e.g., in the form of new news items), and for which an estimate of the demographics of the users who can read it can be obtained. It can be challenging to estimate the demographics of a brand new news item, where a new news item, or webpage, can be one where little or no users have clicked on it, read it or otherwise indicated their interest in it. Exemplary embodiments of the systems, methods and computer-accessible mediums, according to the present disclosure can utilize an exemplary approach which can be relevant to those entities which have demographics on some subset of the users. Firms can have such data for various reasons, including because they can have subscribers, but this information can also be obtained via credit-card purchases, cookie-based third-party data, or via other data conduits. The exemplary system, method and computer accessible medium can be used for news items, and it can also be applicable to any domain where new content can be generated continually, and where it can be desired to predict/estimate the demographics of those who visit the content, especially before many people have visited or otherwise indicated interest in the content (e.g. blog posts, social media posts, etc.).

These and other objects of the present disclosure can be achieved by provision of systems, methods and computer-accessible mediums for generating a demographics model, which can include receiving information related to a plurality of clusters of a plurality of content information, estimating demographics information for each of the clusters, and generating the demographics model based at least in part on the estimated demographics. Further information related to further content information can be received, and the demographics of the further information can be estimated based on the demographics model. The content information can include a previously generated news item. Clusters of the content information can be generated based on users viewing previously generated content information.

In another embodiment of the present disclosure can be systems, methods and computer-accessible mediums for estimating demographics for content information, which can include receiving data related to the content information, and estimating the demographics of the content information based on a predictive demographics model. The predictive demographics model can be generated by receiving further information related to a plurality of clusters of a plurality of further content information, estimating demographics for each of the clusters, and generating the predictive demographics model based at least in part on the estimated demographics.

In some exemplary embodiments of the present disclosure the clusters can be generated based on a similarity of data within each of the clusters and a dissimilarity of data between each of the clusters. In some exemplary embodiments of the present disclosure, the clusters can be generated based on a bigraph(s) having users as a first type of nodes, content as a second type of the nodes and visitation data as edges between the nodes. The bigraph can be generated using a random walk procedure. The content information can be classified using a classification model, which can include a Bayes model, a linear support vector machine, a non-linear support vector machine, a classification-tree based model, a logistic regression model or a K-nearest neighbor model.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary flow diagram of an exemplary method for predicting demographic information for news items according to an exemplary embodiment of the present disclosure;

FIG. 2A is an exemplary diagram illustrating k clusters of news stories, based on clustering the bipartite graph of users and news items according to an exemplary embodiment of the present disclosure;

FIG. 2B is an exemplary diagram illustrating, the building and application of a linear predictive model for estimating demographics according to an exemplary embodiment of the present disclosure;

FIG. 3 is an exemplary flow chart of an exemplary method for estimating demographics information according to an exemplary embodiment of the present disclosure; and

FIG. 4 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

Predicting demographics of the viewers of a webpage can be done in a variety of ways, depending on the available data. Exemplary systems methods and computer accessible mediums can be provided, according to exemplary embodiments of the present disclosure, to utilize several different types of data. Entities can have webpage visitation data, which can be represented as a large bigraph G=<U,W,E>. In exemplary bigraphs, which can be referred to as affiliation or two-mode networks, there can be two types of nodes with edges only between nodes of different types. With the exemplary system, method and computer-accessible medium, users U can be one type of node, webpages W as another, and edges E can be defined by visitation data. The adjacency matrix A, corresponding to this bigraph, can be extremely sparse.

Data on the content of the webpage can be available, and such data can include the text on the webpage, the title of the webpage, the summary, the topical category or other meta-data. The hyperlink structure of a webpage can be available, denoting the other webpages to which a particular hyperlink can refer, or from which it can be referred. The demographics on a subset of users can also be present. The demographics of the visitors to a webpage can be predicted before sufficient users have visited the webpage to calculate the demographics via traditional means (e.g., averaging over the observed with-demographics users).

An exemplary issue can be that news items are continuously being created and published online. To obtain maximum reach and precision for online advertisements, the demographics should be predicted the moment the news item is published. However, at such time, no data on which users have read it (e.g., webpage visitation data) can be available. Demographics can be any properties of a user that reads the news item (e.g., geographies, sociographics, psychographies, conversion probability for an ad, emotional state, sentiment, liking a product/service/brand, etc.). The exemplary system, method and computer-accessible medium, according to an exemplary embodiment of the present disclosure, can utilize behavioral news item reading data, textual data of the news items, and available demographics of the registered users, and can make predictions for a new news items before anyone has even read it, and before there have been a sufficient number of readers for whom their demographics are known, and on which traditional methods that can estimate demographic estimates can be based. As a matrix row for a story gets filled out when users read the news item, the demographics can become easier to estimate. However, the news item can become less interesting as a base for advertising, except for all but the most popular news items, as fewer, and fewer users may be reading the item from then on.

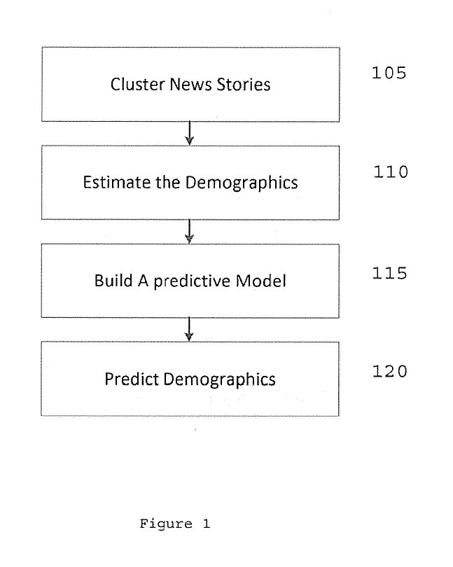

According to an exemplary embodiment, the exemplary system, method and computer-accessible medium, according to the present disclosure can be based on a multistage (e.g., a four-stage) design. (See, e.g., FIG. 1). This can be illustrated in FIG. 1, which can show, for example an exemplary method for predicting user demographics. For example, at procedure 105, news stories can be clustered. This can be based on any data, but preferably can be based on historical data of users visiting news items (e.g., via co-clustering). At procedure 110, the demographics of each cluster can be estimated based on the corresponding users' demographics. At procedure 115, an exemplary predictive model can be built where, for a given news item, or a previously unseen news item, the exemplary model can predict the probability that the news item can belong to each cluster. At procedure 120, for a desired news story, estimate the demographics based on all the clusters and the estimated probabilities. For the news item, the predicted demographics can be a chosen aggregation of the estimated demographics of the individual clusters. An exemplary selection for the aggregation can be the weighted sum of the demographics over the different clusters, weighted by the probability of the news item being a member of a particular cluster. This can be seen as the expected value of the demographics, based on the probability model and the data on visitations to prior stories in the clusters. Another exemplary choice can be where one cluster can be chosen for prediction.

### Exemplary Clustering of User-News Item Dam

Clustering can be a descriptive data-mining task, where data instances can be divided into sets called clusters with high similarity among the data instances within a cluster, and high dissimilarity across clusters. Clustering applied to real-world network data, such as the exemplary user-news item visitation data, can aim to find communities with high concentrations of edges within a community/cluster, and a low concentration across clusters. Real-world networks can demonstrate high levels of modularity, which can facilitate grouping of nodes that can share common properties and/or play a similar role within the graph. (See, e.g., Reference 4). Within social networks, for example, communities can be groups of friends, or simply groups of people sharing coming tastes.

Clustering bigraph data, also known as bi-clustering, co-clustering or two-mode modeling, has received some attention in the past, and there can be many possible techniques, including block clustering, Coupled Two-Way Clustering (“CTWC”), interrelated Two-Way Clustering (“ITWC”), δ-bicluster, δ-pCluster, δ-pattern, flexible overlapped biClustering (“FLOC”), order preserving clusters (“UPC”), Plaid Model, Order-preserving submatrixes (“OPSMs”), Gibbs, Statistical-Algorithmic Method for Bicluster Analysis (“SAMBA”), Robust Biclustering Algorithm (“RoBA”), Crossing Minimization, cMonkey, probabilistic relational models (“PRMs”), double conjugated clustering (“DCC”), Localize and Extract Biclusters (“LEB”), QUalitative BiClustering (“QUBIC”), Bi-Correlation Clustering Algorithm (BCCA”) and Factor Analysis for Bicluster Acquisition (“FABIA”).

Many other exemplary clustering procedures can be utilized for homogenous graphs. (See, e.g., Reference 4). For example, such exemplary clustering procedures, which can be used on the user-news item data by defining a network among users with links if they have read the same news item, and vice versa, can network among news items linked if read by the same user. The exemplary systems, method and computer-accessible medium, according to exemplary embodiments of the present disclosure, can handle, for example, millions of nodes using a random walk approach. (See e.g., Reference 15). For example, a random walker can start in some node and take a limited number of steps to its neighbors, and can be likely to remain within the community. For example, numerous short random walks can be performed starting in each of the nodes, and nodes can be interpreted on the same path as likely belonging to the same community. This can create an exemplary similarity matrix that can indicate the probability of two nodes being on a path of a random walker. This matrix can then be used to incrementally merge nodes into clusters.

Another exemplary version of co-clustering can be to cluster the documents (e.g. with topic modeling), and add all users that read any of the documents to the cluster. Note that these clusters can overlap.

In the exemplary news-item setting, an exemplary online system can likely be utilized, where new news items can be added on the fly, for example, by adding to the cluster that can be most similar to the current news item. This also can facilitate performing clustering on a sample. Additionally, an exemplary “soft clustering” solution, where a data instance can belong to several clusters (e.g. with a probability for each), can be useful for the further steps, although it may not be necessary.

### Exemplary Estimation of the Demographic Distribution Per Cluster

Within a cluster, based on all users with known demographics, for example, the distribution of the demographics within that cluster can be determined/computed. Based on this exemplary distribution, an estimate of the demographic “profile” can′ an be obtained for the complete cluster along any demographic dimension, for example, by taking the average, median or mode (e.g., the most frequent age range), or by representing the distribution in more detail (e.g., the distribution across the age ranges). This can be performed for each demographic dimension and the demographic distribution across all dimensions for cluster I can be denoted by dᵢ.

### Exemplary Cluster Prediction for a Given News Item

For a given news item, an exemplary predictive model can be produced/provided that can facilitate probabilities for belonging to each cluster, Most or all available data on that news item can be used to make a prediction, such as the textual data, but also category data (e.g., is it political, business, sports, etc.), or even data on some users who have read the news item, which can become available over time. Where only textual data can be available, the exemplary system, method and computer-accessible medium, according to an exemplary embodiment of the present disclosure, can be extended to including additional data.

Exemplary document classification systems can classify text documents automatically, based on the words, phrases and word combinations therein. In the input data, each row can correspond to a document, each column to a word, or more generally to a “term”, which can be, for example, a phrase or an n-gram, and the value can be the term frequency in the document. The exemplary systems, method and computer-accessible medium can build document classification models, which can include naive Bayes, linear and non-linear support vector machines (“SVMs”), classification-tree based methods often used in ensembles (e.g., boosting), K-nearest neighbor and various other models. (See, e.g., Reference 5).

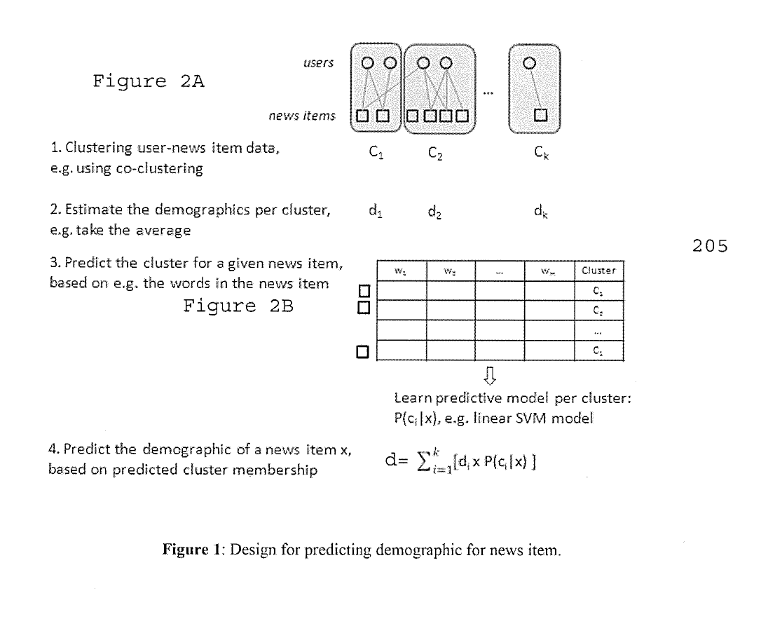

FIG. 2B shows a diagram illustrating the building and application of an exemplary linear predictive model for estimating demographics. The top of the graph, element 205, is a data matrix where each cluster can be described by m features, which can be, for example, weighted frequencies of words. Then a predictive model p(cilx) can be induced from the data matrix, which can be, for example, a linear support vector machine. A demographics variable d can be estimated by summing over the cluster-specific demographics value di for each cluster i, weighted by the estimated probability that a new news article x belongs to each cluster i.

The exemplary class to predict case can be the cluster to which the news item can belong. There can be hundreds or thousands of clusters, the total number of which can be denoted by k, which can lead to hundreds or thousands of models to be built. This in itself may not be an issue, as the evaluation of these models can be very fast.

Therefore, an exemplary model, or set of models M, can be provided that, for each cluster ci and news item n, can predict the probability n belongs to ci: M.: ci, n→P(ci|n).

### Exemplary Prediction of the Demographic Distribution of a News Item, Based on Predicted Cluster Membership and Cluster Demographic Distributions

For a news item x, and particularly for a new news item, the k predictive models can be applied to obtain membership probabilities for all clusters: P(cᵢ|x), P(c₂|x), . . . , P(cₖ|x). For each cluster, its estimated demographic distribution can also be obtained (e.g., d₁, d₂, . . . , dₖ).

The predicted demographic distribution for news item x can be defined as the weighted sum of the estimated cluster demographics values:

$$Predicted demographic distribution ( x ) = {\sum }_{i = 1}^{k} [ {d}_{i} \times P ( {c}_{i} \vert x ) ]$$

where the sum (e.g., the weighted sum) can be taken component-wise across the vectors. For hard classification solutions, where a news item can be predicted to belong to only to one cluster (e.g., cⱼ), this can correspond to the estimation of the demographic distribution of that specific cluster (dⱼ). In certain exemplary cases, weights can be learned based on some exemplary outcome (e.g., a click on an ad or purchase of a targeted product).

### Exemplary Application(s) of Exemplary Embodiments of Present Disclosure

Exemplary Advertising Based on Demographics

An exemplary application can include where advertisers wish to target users of some specific demographic or demographic distribution. By placing an ad on those online news items whose predicted demographics can correspond to the specified demographics, the intended audience can likely be reached.

Exemplary Estimation of Conversion Rates Per News Item

Advertisers may be interested in showing advertisements in conjunction with those news items, which can provide the highest conversion rates. For news items that have existed for some time, the average, other exemplary aggregate, or conversion rate seen for that news item can be estimated. For new news items, however, this may not be possible, as not enough ads can have been shown on that page. The conversion rate for a new news item can be predicted by considering the conversion rate as a demographic dimension to predict an estimated conversion rate per cluster, which can easily be obtained (e.g., by averaging the conversion rates for the news items in the cluster). There can also be probabilities for a new news item to belong to any of the k clusters. By taking the weighted average conversion rate, an estimate for news item x can be provided.

Exemplary Prediction of Properties of any Entity Type Related to News Items

Although the exemplary system, method and computer-accessible medium, according to certain exemplary embodiments of the present disclosure, can be used for predicting demographics of news items, the exemplary procedures utilized therein can also be applicable to predict properties of any entity type related to a news items. The previously mentioned exemplary application can predict click-through rates of ads (e.g., properties) shown on (e.g., related to) online news items. Another exemplary use case can be predicting the sentiment of comments (e.g., properties) written in response to (e.g., related) news items.

Exemplary Prediction of User Demographics

When webpage demographics can be estimated, this can be used to infer user demographics, by, for example, taking a weighted sum of the demographics of the news items the user read.

Exemplary Prediction of Users to Target Based on Estimated Demographics

The exemplary predicted/estimated demographic values can be used as input variables to predict the conversion rate of a news item. Given a training dataset of news items with observed conversion rates (e.g. estimated or real demographics), a predictive model can be built that can predict conversions based on the provided demographics. For, a new news item, the predicted/estimated demographics can be determined (e.g., as described above), and then used as input to an exemplary conversion-rate prediction model.

As indicated herein, the exemplary system, method and computer-accessible medium according to the exemplary embodiment of the present disclosure can be applicable to any domain where new content can be generated and continually added, and where it can be desired to predict/estimate the properties of those who visit the content, especially before many people have visited or otherwise indicated interest (e.g. blog posts, social media posts, etc.).

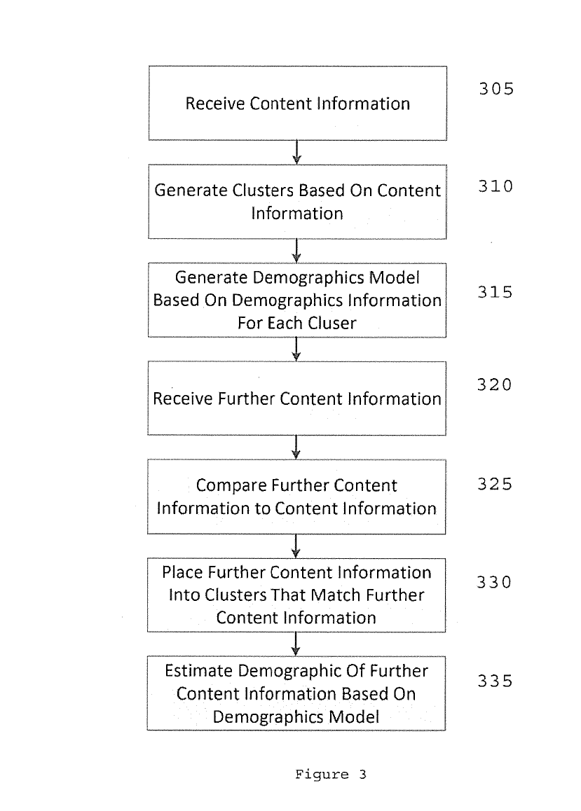

FIG. 3 illustrates a flow diagram of an exemplary method for estimating demographics information. For example, at procedure 305, content information can be received, which can be separated into clusters in procedure 310. At procedure 315, a demographics model can be generated based on demographics information for each cluster. Further content information can be received at procedure 320, which can be compared to the content information at procedure 325. At procedure 330, the further content information can be placed into the clusters that match the further content information. At procedure, 335, the demographics information for the further content can be estimated based on the demographics model.

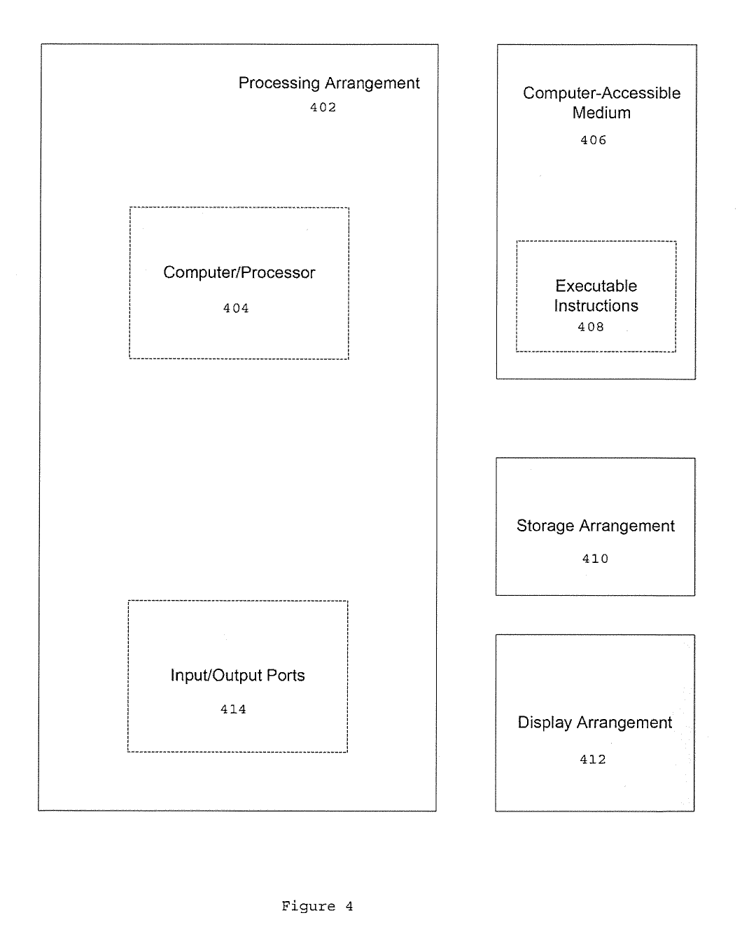

FIG. 4 shows a block diagram of an exemplary embodiment of a system according to the present disclosure. For example, exemplary procedures in accordance with the present disclosure described herein can be performed by a processing arrangement and/or a computing arrangement 402. Such processing/computing arrangement 402 can be, for example, entirely or a part of or include, but not limited to, a computer/processor 404 that can include, for example, one or more microprocessors, and use instructions stored on a computer-accessible medium (e.g., RAM, ROM, hard drive, or other storage device).

As shown in FIG. 4, for example, a computer-accessible medium 406 (e.g., as described herein above, a storage device such as a hard disk, floppy disk, memory stick, CD-ROM, RAM, ROM, etc., or a collection thereof) can be provided (e.g., in communication with the processing arrangement 402). The computer-accessible medium 406 can contain executable instructions 408 thereon. In addition or alternatively, a storage arrangement 410 can be provided separately from the computer-accessible medium 406, which can provide the instructions to the processing arrangement 402 to configure the processing arrangement to execute certain exemplary procedures, processes and methods, as described herein above, for example.

Further, the exemplary processing arrangement 402 can be provided with or include an input/output arrangement 414, which can include, for example, a wired network, a wireless network, the internet, an intranet, a data collection probe, a sensor, etc. As shown in FIG. 4, the exemplary processing arrangement 402 can be in communication with an exemplary display arrangement 412, which, according to certain exemplary embodiments of the present disclosure, can be a touch-screen configured for inputting information to the processing arrangement in addition to outputting information from the processing arrangement, for example. Further, the exemplary display 412 and/or a storage arrangement 410 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety.
[1] Lada A. Adamic, Eytan Adar, Francine R. Chen (2007). User profile classification by web usage analysis. U.S. Pat. No. 7,162,522 B2. Xerox Corporation.
[2] Bin Bi, Milad Shokouhi, Michal Kosinski, and Thore Graepel (2013). Inferring the Demographics of Search. Users, in 22nd International World Wide Web Conference, A C M, 2013.
[3] Koen De Bock and Dirk Van den Poel. 2010. Predicting Website Audience Demographics for Web Advertising Targeting Using Multi-Website Clickstream Data. Fundam. Inf. 98, 1 (January 2010), 49-70.
[4] Fortunato S. Community detection in graphs. Phys. Rep., 486:75-174, 2010.
[5] Hotho, A., A. Nurnberger, G. Paass. 2005. A brief survey of text mining. LDV Forum 20(1) 19-62.
[6] Jian Hu, Hua-Jun Zeng, Hua Li, Cheng Niu, and Zheng Chen. 2007. Demographic prediction based on user's browsing behavior. In Proceedings of the 16th international conference on World Wide Web (WWW '07). ACM, New York, N.Y., USA, 151-160.
[7] Santosh Kabbur, Eui-Hong Han, and George Kaiypis (2010). Content-Based Methods for Predicting Web-Site Demographic Attributes. In Proceedings of the 2010 IEEE International. Conference on Data. Mining (ICDM '10). IEEE Computer Society, Washington, D.C., USA, 863-868.
[8] Ching Law, Gokul Rajaram, Rama Ranganath (2012) Determining a demographic attribute value of an online document visited by users. U.S. Pat. No. 8,321,249 B2. Google Inc.
[9] John W. Merrill (2012) U.S. Pat. No. 8,190,475 B1. Visitor profile modeling. Google Inc.
[10] Abha Moitra, Steven Matt Gustafson, Feng Xue (2012) Methods and systems for mining websites. U.S. Pat. No. 8,219,583 B2. NBC Universal Media LLC.
[11] Dan Murray, Kevan Durrell (2000) Inferring Demographic Attributes of Anonymous

Internet Users. Web Usage Analysis and User Profiling, Lecture Notes in Computer Science Volume 1836, 2000, pp 7-20.
[12] T. Raeder, C. Perlich, B. Dalessandro, O. Stitelnian, F. Provost (2013) Scalable supervised dimesionality reduction using clustering.
[13] Manjunath Srinivasaiah (2011) U.S. Pat. No. 8,073,807—Inferring demographics for website members. Google
[14] Deerwester, S., Dumais, S. T., Furnas, G. W., Landauer, T. K., & Harshman, R. (1990). Indexing by latent semantic analysis. Journal of the society for information science, 41(6), 391-407.
[15] Karsten Steinhaeuser, Nitesh V. Chawla (2010). Identifying and evaluating community structure in complex networks. Pattern Recognition Letters 31(5), 413-421.

What is claimed is:

1. A non-transitory computer-accessible medium having stored thereon computer-executable instructions for generating a demographics model, wherein, when a computer hardware arrangement executes the instructions, the computer arrangement is configured to perform procedures comprising:
receiving information related to content information;
generating a plurality of clusters based on the content information; and
generating a demographics model based on demographics information for each of the clusters.

2. The non-transitory computer-accessible medium of claim 1, wherein the computer hardware arrangement is further configured to receive further information related to further content information, and estimate the demographics information of the further information based on the demographics model.

3. The non-transitory computer-accessible medium of claim 2, wherein the computer hardware arrangement is further configured to estimate the demographics information of the further information by comparing the further content information to the content information, and placing the further content information into at least one particular cluster of the clusters that match the further content information.

4. The non-transitory computer-accessible medium of claim 3, wherein the computer hardware arrangement is further configured to apply the demographics information for the at least one particular cluster to the further content information.

5. The non-transitory computer-accessible medium of claim 3, wherein the computer hardware arrangement is further configured to place the further content information into the at least one particular cluster based on a probability that the further content information matches the content information of the at least one particular cluster.

6. The non-transitory computer-accessible medium of claim 1, wherein the content information includes at least one previously generated news item.

7. The non-transitory computer-accessible medium of claim 1, wherein the computer hardware arrangement is further configured to generate the clusters based on at least one of readers of the content information or a particular criteria of the content information.

8. The non-transitory computer-accessible medium of claim 1, wherein the computer hardware arrangement is further configured to generate the demographics models based on readers of the content information in the clusters.

9. The non-transitory computer-accessible medium of claim 1, wherein the computer hardware arrangement is further configured to generate the clusters based on a similarity of data within each of the clusters and a dissimilarity of data between each of the clusters.

10. The non-transitory computer-accessible medium of claim 1, wherein the computer hardware arrangement is further configured to generate the clusters based on at least one bigraph having users as a first type of nodes, content as a second type of the nodes and visitation data as edges between the nodes.

11. The non-transitory computer-accessible medium of claim 10, wherein the computer hardware arrangement is further configured to generate the bigraph using a random walk procedure.

12. The non-transitory computer-accessible medium of claim 1, wherein the computer hardware arrangement is further configured classify the content information using a classification model.

13. The non-transitory computer-accessible medium of claim 12, wherein the classification model include at least one of Bayes model, a linear support vector machine (SVM), a non-linear SVM, a classification-tree based model, a logistic regression model or a K-nearest neighbor model.

14. A non-transitory computer-accessible medium having stored thereon computer-executable instructions for estimating demographics for new content information, wherein, when a computer hardware arrangement executes the instructions, the computer arrangement is configured to perform procedures comprising:
receiving data related to the new content information; and
estimating the demographics of the new content information based on a predictive demographics model by matching the new content information to previous content information in a plurality of clusters.

15. The non-transitory computer-accessible medium of claim 14, wherein the computer hardware arrangement is further configured to place the new content information in at least one cluster based on a probability that the new content information matches the previous content information in a particular cluster

16. The non-transitory computer-accessible medium of claim 14, wherein the computer hardware arrangement is further configured to generate the predictive demographics model.

17. The non-transitory computer-accessible medium of claim 16, wherein the computer arrangement generates the predictive demographics model by:
receiving information related to previous content information;
generating the clusters based on the previous content information; and
generating the demographics model based on the demographics information for each of the clusters of the plurality of clusters.

18. The non-transitory computer-accessible medium of claim 14, wherein the new content information and the previous content information are news items.

19. A method for generating a demographics model, comprising:
receiving information related to content information;
generating a plurality of clusters based on the content information; and
using a computer hardware arrangement, generating a demographics model based on demographics information for each of the clusters.

20-31. (canceled)

32. A method for estimating demographics for new content information, comprising:
receiving data related to the new content information; and
using a computer hardware arrangement, estimating the demographics of the new content information based on a predictive demographics model by matching the new content information to previous content information in a plurality of clusters.

33-36. (canceled)

37. A system for generating a demographics model, comprising:
a computer hardware arrangement configured to:
receiving information related to content information;
generating a plurality of clusters based on the content information; and
using a computer hardware arrangement, generating a demographics model based on demographics information for each of the clusters.

38-49. (canceled)

50. A system having stored thereon computer-executable instructions for estimating demographics for new content information, wherein, when a computer hardware arrangement executes the instructions, the computer arrangement is configured to perform procedures comprising:
receiving data related to the new content information; and
estimating the demographics of the new content information based on a predictive demographics model by matching the new content information to previous content information in a plurality of clusters.

51-54. (canceled)
